(19) United States
(12) Patent Application Publication
(10) Pub. No.: US 2011/0073125 A1
(43) Pub. Date: Mar. 31, 2011

(54) Press-on multicolor application system and method

(76) Inventor: Irina Iosilevich, Boca Raton, FL (US)

(21) Appl. No.: 12/004,692

(22) Filed: Dec. 21, 2007

Related U.S. Application Data
(60) Provisional application No. 60/876,634, filed on Dec. 22, 2006.

(51) Int. Cl. A45D 40/00; B05D 1/02; B05D 1/36; B32B 37/00; B05D 3/06

(52) U.S. Cl. 132/200; 132/333; 132/320; 427/421.1; 427/402; 156/60; 427/558

(57) ABSTRACT

An assortment of color applicators apply cosmetic colors to specific regions of the user body including an instant eye shadow applicator, instant blush applicator, instant powder applicator, instant eye brow applicator, instant eye concealer, lip liner, eye liner, mascara, nails and deodorant applicator, instant lipstick applicator, instant hair applicator and musk applicator. All of these applicators apply color directly to bare user skin or on top of an already colored area of user skin. Each application includes a soft color carrier sheet, impregnated with a pre-measured amount of cosmetic material optionally fortified with vitamins, moisturizers and different application pigments. The various applicators of the system include carrier sheets in a variety of sizes, shapes, color combinations and types, which are sufficiently inexpensive to be disposable. The carrier sheet can be cut into unique shapes to help apply cosmetic material easily to normally hard to reach blending areas of the body.

### FILING HISTORY

This application continues from provisional patent application Ser. No. 60/876,634, filed on Dec. 22, 2006.

### BACKGROUND OF THE INVENTION

1. Field of the Invention

The present invention relates generally to the field of cosmetics application devices and methods. More specifically the present invention relates to an assortment of color applicators for applying cosmetic colors to specific regions of the user body including an instant eye shadow applicator, instant blush applicator, instant powder/make-up foundation applicator, instant eye brow applicator, instant under eye concealer applicator, instant lipstick/lip liner applicator, lip gloss, instant hair applicator and mask applicator, as well as eye liner, mascara, nails and deodorant applicators. All of these applicators apply color directly to bare user skin, hair or nails or on top of an already colored area of user skin.

Each applicator includes a soft color carrier sheet, impregnated with a pre-measured amount of cosmetic material and rapid application pigments fortified with vitamins, moisturizers and anti-microbial and antibacterial agents.

Where multiple coats of cosmetic material are required, each coat after the first can be applied immediately, before the previous coat has dried, a procedure which is termed wet on wet application. As a result, one transferred coating image such as a pattern or design to the skin or hair can be followed immediately by another applied coat.

The various applicators of the system include carrier sheets in a variety of sizes, shapes, color combinations and types, which are sufficiently inexpensive to be disposable. The carrier sheet can be cut into unique shapes to help apply cosmetic material easily to normally hard to reach blending areas of the face and body. The general applicator used for this system includes a carrier sheet formed of woven or non-woven material, and has a forward face which is impregnated with pigment material defining a single color or multiple color combinations. The applicator carrier sheet has a rearward face which optionally includes pockets or loops for receiving user middle and ring fingers and separately the index finger. A method of use is provided including the steps of fitting a hand to the applicator with long sides connected together by a strap.

2. Description of the Prior Art

There have long been applicators for applying cosmetic material to various areas of a user body. A problem with these prior applicators and methods of use has been that it is time consuming to construct and the quality of the image depends on the skill of the user. Another problem is that the prior applicators such as brushes are relatively expensive and cumbersome to carry and mail. Yet another problem is that the expense of the prior applicators often makes reuse necessary, which is not sanitary and hygienic.

It is thus an object of the present invention to provide a press-on applicator which instantly delivers a desired pigment material image onto user skin, nails or hair with a single touch of the applicator and the resulting image is consistently correct and exact, with no need of the services of a professional person to create the image.

It is another object of the present invention to provide such an applicator and method of use which does not require the use of a second applicator to complete the application.

It is finally an object of the present invention to provide such an applicator which is very inexpensive to manufacture to be disposable after a single use and thus to provide hygienic cosmetic application.

### SUMMARY OF THE INVENTION

The present invention accomplishes the above-stated objectives, as well as others, as may be determined by a fair reading and interpretation of the entire specification.

A press-on cosmetic material applicator is provided, including a carrier sheet having a sheet forward face hand having a sheet rearward face and retaining a pre-measured amount of pigment material configured to define an image.

The cosmetic material preferably includes at least a single pigment configured to define an image, or includes a number pigments configured to define an image. The cosmetic material preferably includes at least one of: a vitamin, a moisturizer, an anti-microbial agent, an antibacterial agent, organic material, non-organic material, a jell, an exfoliator, a medication, a skin treatment, a deodorant and a tanning lotion. The image preferably is a region having an image perimeter containing the pigment material and having a specific image perimeter shape and size. The image perimeter shape preferably is the shape of one of: a human lip, a human eyebrow, and human fingernail.

The forward face of the carrier sheet preferably is substantially fully covered with the pigment material and the carrier sheet preferably has a sheet perimeter with a sheet perimeter shape of one of: a human lip, a human eyebrow, and a human fingernail. The pigment material preferably includes one of: instant powder, lipstick, eye shadow, blush, eye concealer, mascara lip liner, eye liner and nail polish. The carrier sheet preferably is formed of inexpensive material to be disposable. Further, the carrier sheet preferably is formed of sheet material including woven material or including non-woven material. The sheet forward face preferably retains the cosmetic material and a sheet rearward face preferably includes one of: a finger receiving pocket and a finger receiving loop for receiving at least one user finger with which the user holds and moves the carrier sheet for cosmetic material application.

A method of manufacturing a press-on cosmetic material applicator is provided, including the steps of providing a carrier sheet having a sheet forward face and a sheet rearward face; spraying the sheet forward face with cosmetic material in at least one coat. The cosmetic material preferably includes pigment materials and of varying levels of darkness the step of spraying the sheet forward face with cosmetic material includes the sub-steps of: spraying a first coat of the lightest pigment material shade; then spraying a second coat of darker pigment material onto the first coat, and then spraying a third coat of still darker pigment material onto the second coat. The cosmetic material preferably is sprayed onto the carrier sheet forward face through a wet process such that the cosmetic material remains on the sheet forward face until transferred directly to user skin. The method preferably includes the additional step of curing the cosmetic material with ultraviolet light to sterilize the cosmetic material and to eliminate the need for preservatives.

A method of applying pigment material with a press-on pigment material applicator comprising a carrier sheet having a sheet rearward face and having a sheet forward face with a plurality of carrier sheet regions including first, second and third regions, each carrier sheet region including pigment material of a color different from the colors of the pigment materials of other carrier sheet regions is provided, including the steps of pressing a first region of the sheet forward face having darker pigment material onto user skin to form a contouring line; pressing a second region of the sheet forward face having a brighter pigment material onto user skin; and pressing a third region of the sheet forward face having a highlighter pigment material onto user skin to highlight.

A method of using an eyeliner applicator including a carrier sheet having a sheet forward face and having a sheet rearward face and retaining a pre-measured amount of pigment material configured to define an image, where the carrier sheet forward face has several carrier sheet regions, each carrier sheet region including pigment material of a color different from the colors of the pigment materials of other carrier sheet regions is provided, including the steps of selecting and closing a user eye; centering the carrier sheet applicator on the eyelid of the selected user eye; holding the carrier sheet centered on the user eyelid with one hand and using a fingertip on the user free hand to rub at least two of the several carrier sheet regions of the carrier sheet forward face on the eyelid; and removing the sheet from the eyelid.

A method of using an lip liner applicator comprising a carrier sheet having a sheet forward face hand having a sheet rearward face and retaining a pre-measured amount of pigment material configured to define an image is provided, including the steps of the user smiling; the user stretching user lips wide and slightly opening the user mouth; placing the carrier sheet forward face to substantially the center of the corresponding user lip such that the image is aligned with the perimeter lines of the user lip, and then starting at the center and working outwardly, using fingers to smooth the carrier sheet against the user lip. The carrier sheet preferably provides a guard for one of eyelash make-up and eyeshadow, functioning as a masking sheet.

### BRIEF DESCRIPTION OF THE DRAWINGS

Various other objects, advantages, and features of the invention will become apparent to those skilled in the art from the following discussion taken in conjunction with the following drawings, in which:

FIGS. 1-28 illustrate the preferred embodiments of the present invention.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

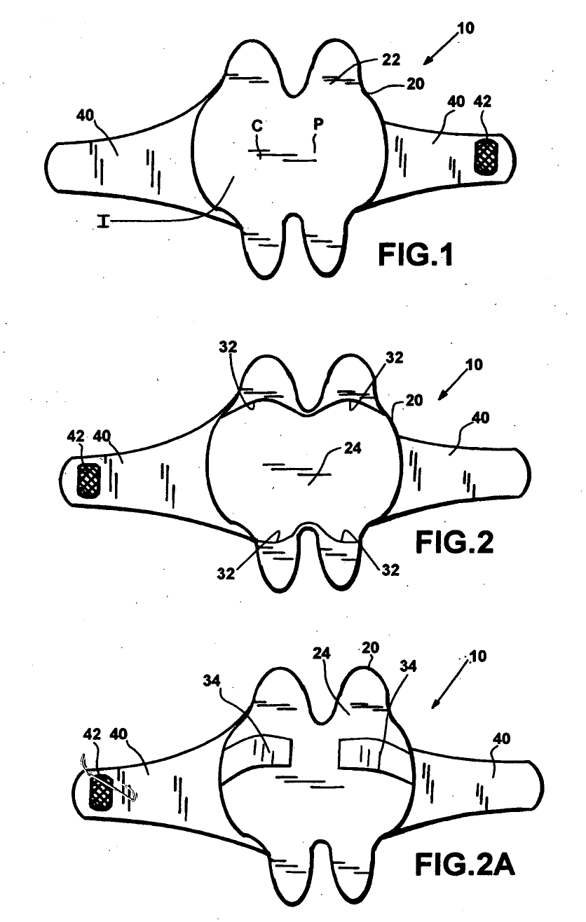

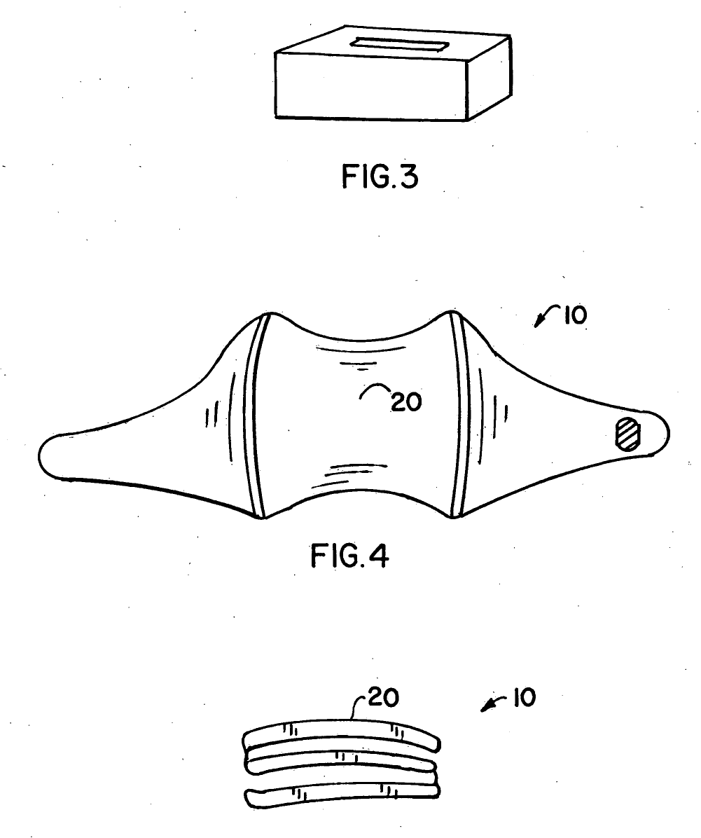

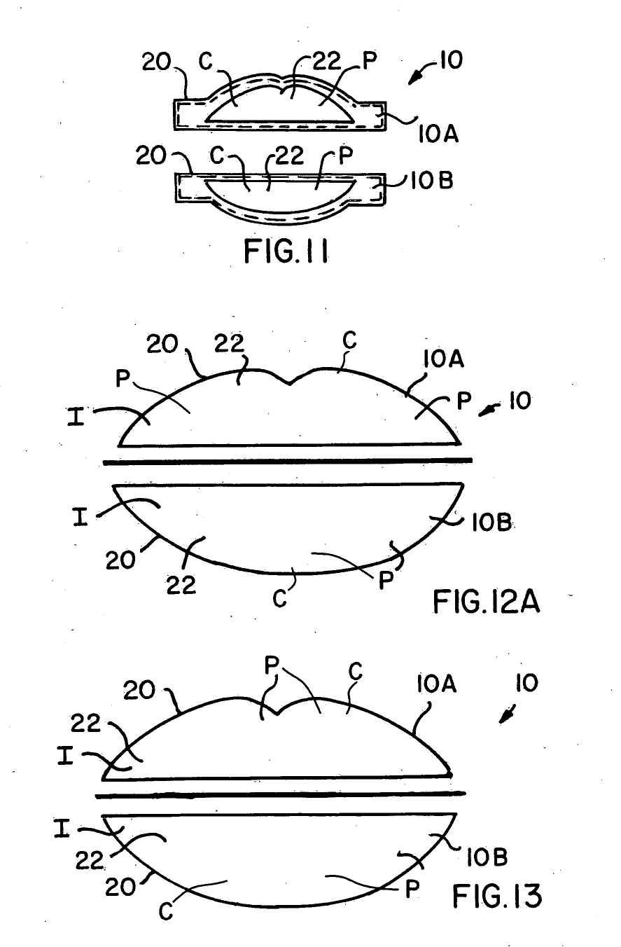

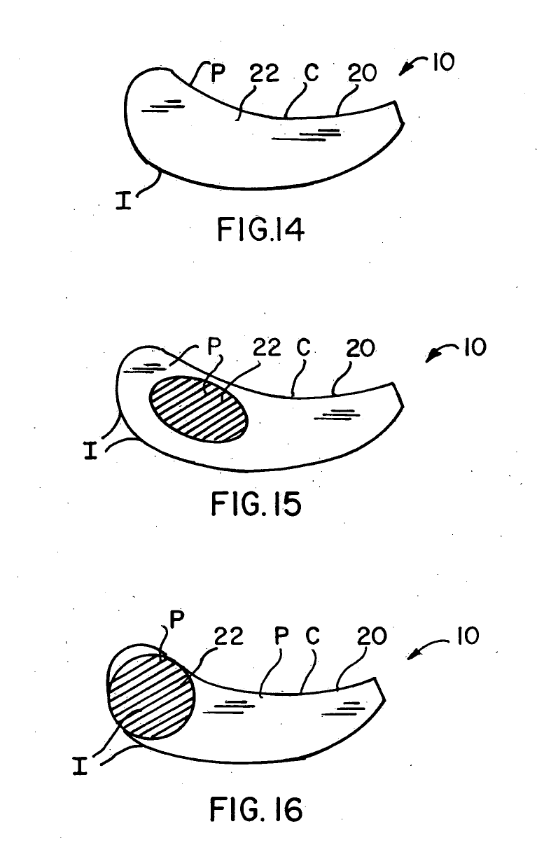

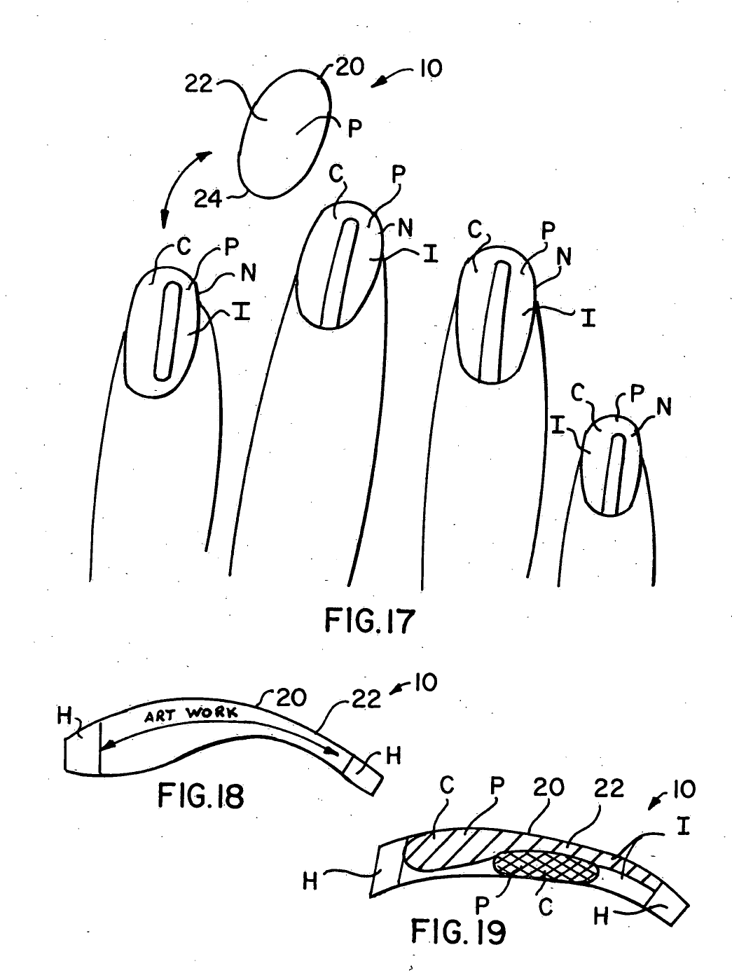

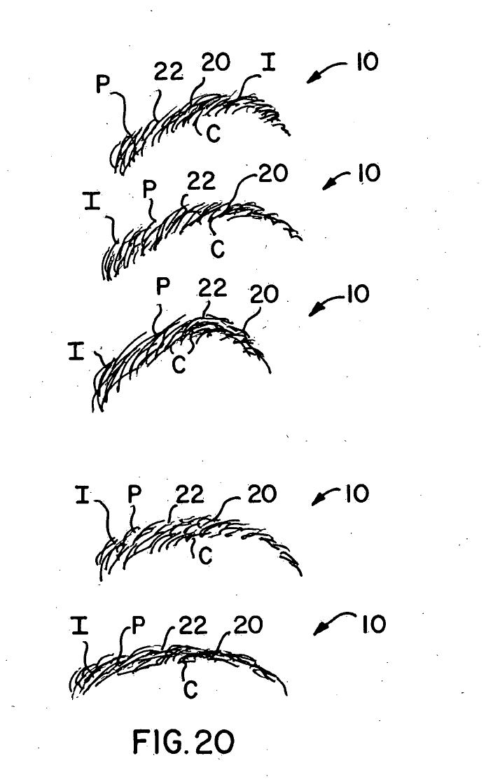

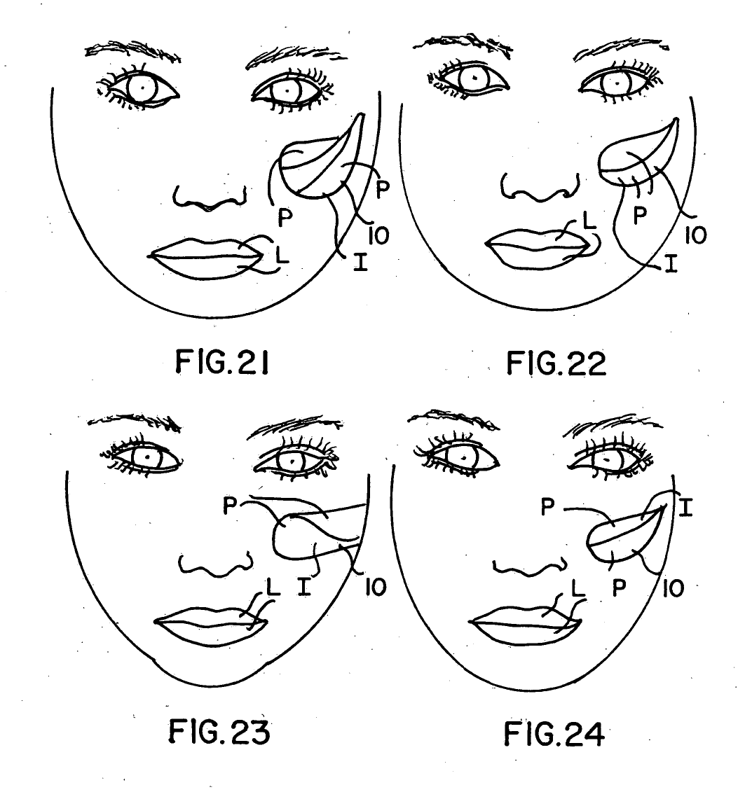

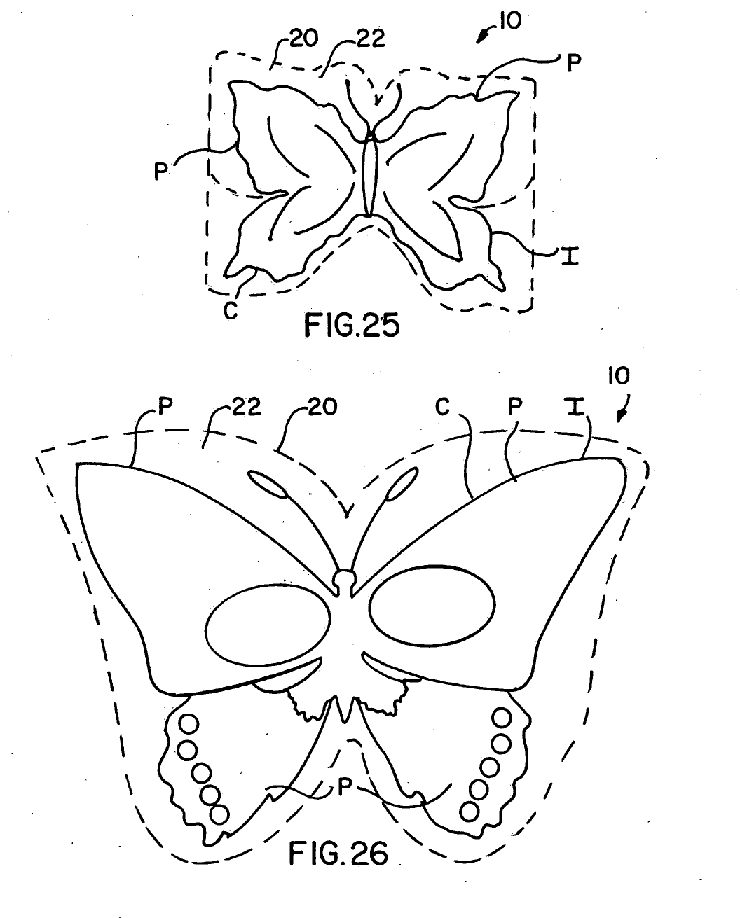

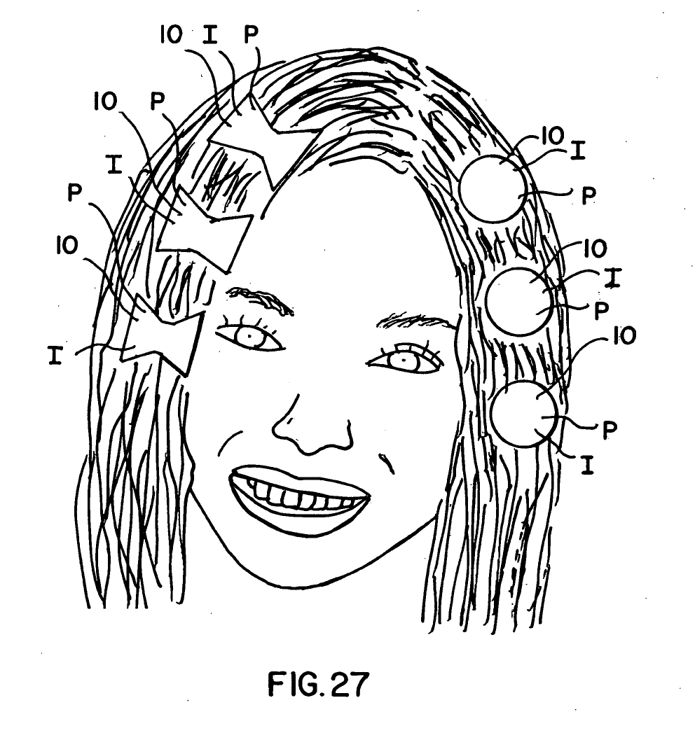

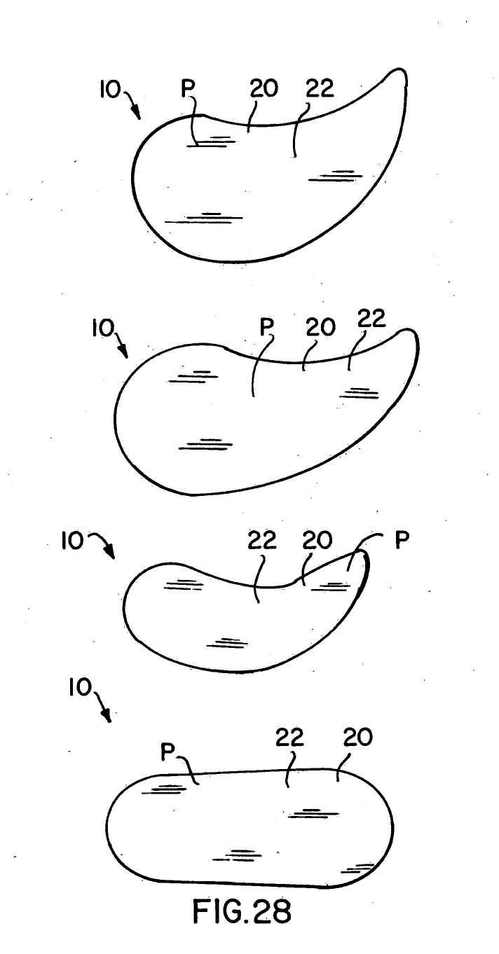

Referring to FIGS. 1-28, an assortment of press-on color applicators are disclosed for applying cosmetic colors to specific regions of the user body including an instant eye shadow applicator, instant blush applicator, instant powder applicator, instant eye brow applicator, instant under eye concealer applicator, instant lipstick applicator, instant hair applicator, musk applicator, and lipstick, lip liner, eye liner, mascara, nails and deodorant applicators. All of these applicators apply color directly to bare user skin hair or nails or on top of an already colored area of user skin.

Each applicator 10 includes a soft color carrier sheet, impregnated with a pre-measured amount of cosmetic material fortified with vitamins, moisturizers and different pigment material P colors. The make-up contains anti-microbial and antibacterial agents.

Where multiple coats of cosmetic material are required, each coat after the first can be applied immediately, before the previous coat has dried, a procedure which is termed wet on wet application. As a result, one transferred coating image I such as a design or pattern to the skin or hair can be followed immediately by another applied coat.

The various applicators of the system include carrier sheets in a variety of sizes, shapes, color combinations and types, which are sufficiently inexpensive to be disposable. The carrier sheet can be cut into unique shapes to help apply cosmetic material easily to normally hard to reach blending areas of the body.

### General Press-On Applicator

The general applicator 10 used for this system includes a carrier sheet formed of woven or non-woven material, and has a forward face which is impregnated with pigment material P defining a single color or multiple color combinations. Various cosmetic material C formulas are provided, including minerals, organic pigment material P, non-organic pigment material P, jells and powders. This general applicator 10 can be used to clean skin, remove make-up and to apply make-up, powder, skin care products, exfoliators, medication, treatments, deodorant, color, self tanning lotion and the like.

The applicator carrier sheet 20 has a sheet forward face 22 and a sheet rearward face 24 which optionally includes pockets 32 or loops 34 and/or arms 40 with fasteners 42 for receiving user middle and ring fingers, plus the index finger. See FIGS. 1 and 2. A method of use includes the steps of fitting a hand to the applicator 10 with long sides connected together by a straps.

### Method of Press-On Applicator Production

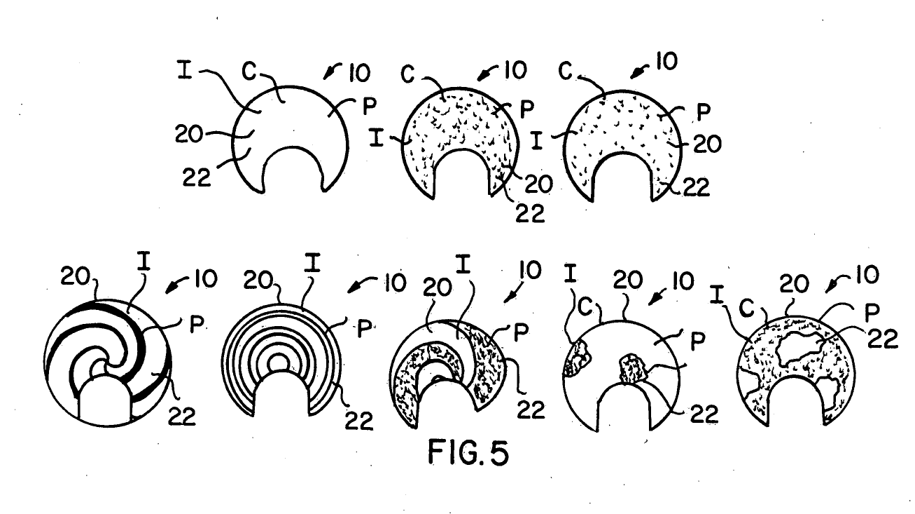

A make-up carrier structure includes a carrier sheet 20, preferably formed of Pelon or other suitable material which is sprayed with the cosmetic material C or a treatment solution in several coats of different shades. For example: a first coat, the lightest shade, preferably the pink pigment is sprayed over an entire carrier sheet forward face 22, then a darker second coat, darker than the first and preferably including beige pigment, is sprayed on top of the first coat, and then a third coat including a still darker pigment material P shade and preferably brown pigment material P, is sprayed on top of the second coat, and so on. The number of coats and color combinations can be varied as desired and the total number of coats possible is virtually unlimited. The resulting color scheme on the carrier sheet 20 includes dots and spots of color. See FIG. 5.

### Press-On Make-Up Transfers

Make-up transfers concerns instant make-up and powder applicators 10. With the use of loose mineral powders, used in make-up foundation, eye shadows, blush, setting powder, bronzers, highlighters, concealers, eye liners, brow definers, primers and lip colors there is a need for instant make-up applicators 10. Loose powders, including minerals, when picked up with the brushes or pads, become airborne and float in the air. When inhaled by the user or a make-up artist the powder sticks to the lungs, jeopardizing the health of the artist, even for people and animals in close proximity—much like second hand smoke).

The present method of application and transferring cosmetic product to the skin is the safest. All dry powders are applied through wet process and as a result stay on the applicator carrier sheet 20 until transferred directly to the skin by being pressed on.

Mineral make-up, used in the present printing or spraying processes, as a finished product with the instant applicators 10 gets cured with ultraviolet (UV) rays and thus is sterilized, eliminating the need for preservatives. This procedure makes the applicator 10 very desirable for people with allergies to cosmetic preservatives.

Applicators 10 are made in different shapes and color combinations (see FIGURES). With the same method of color application other make-up can be used: face foundation, skin primers, concealers, blush, bronzers, and highlighters. One foundation or powder applicator 10 can be used as three applicators as follows:

1. Blush—By Using:

one corner of the carrier sheet forward face 22 impregnated with a darker pigment material P color as a contouring line;

a second corner of the carrier sheet forward face 22 impregnated with a brighter pigment material P color as a main color;

third corner of the carrier sheet 20 forward face 22 impregnated with a highlighter;

2. Eye Shadows:

one corner of the carrier sheet forward face 22 impregnated with a dark pigment material P color as a contouring color in a crease of an eye lid;

a second corner of the carrier sheet forward face 22 impregnated with a complementary color; and a third corner of carrier sheet forward face 22 impregnated with a highlighter.

### Individual Press-On Applicator Characteristics

The individual applicator 10 characteristics are as follows:

### Instant Eye Liner Applicator and Method

The eye liner applicator 10 is a carrier sheet 20 formed of woven or non-woven material, which is impregnated with color: pigment material P defining a color or multiple color combinations. Various cosmetic material C formulas are provided, including minerals, organic colors, non-organic colors, creams, paste, jells and powders or the like.

The eye liner applicator 10 can be used on the upper eyelid and under the user eye. A method of using the eye liner applicator 10 includes the steps of: closing the user eye, centering the applicator 10 on the user eyelid, holding the applicator 10 against and centered on the user eyelid with one hand, using a fingertip of the user free hand to gently rub, press or dab the entire surface of the applicator 10 from inner corner to outer corner, and then removing and disposing of the applicator 10.

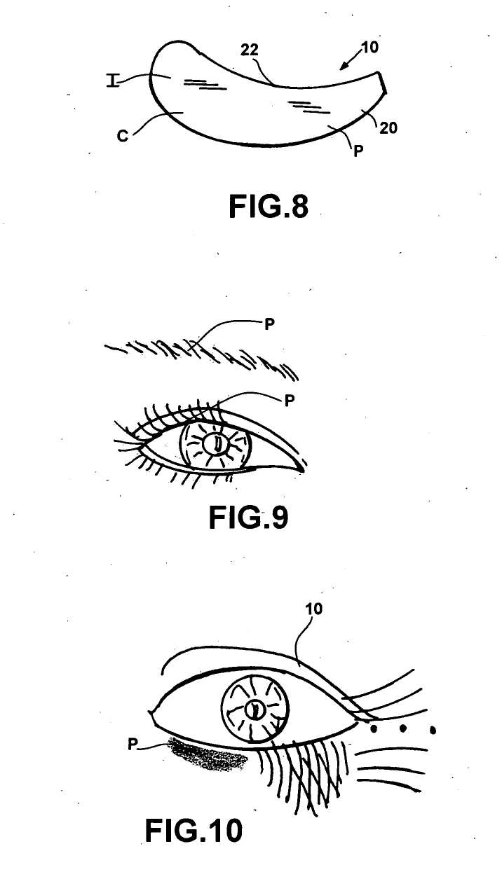

The eye liner applicator 10 is applied in either a neat and narrow line as shown in FIG. 8, or in a broader design for the upper eye lid or under the eye. The eyeliner applicator 10 is excellent for sensitive eyes and contact lens wearers. Eyeliner applicator 10 does not scratch skin with a sharp tip of a pencil, and it does not need sharpening, and is anti-microbial and inexpensively manufactured for one time use. Either a single pigment material P color or multiple pigment material P colors are applied with just one touch application 10.

### Instant Lipstick Applicator and Method

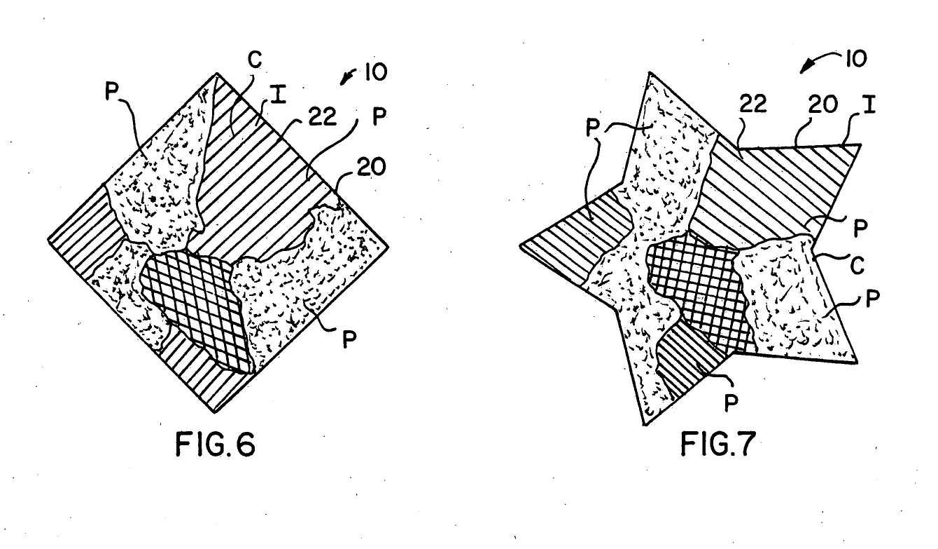

A lipstick applicator set 10 is provided including an upper lip applicator 10A in the form of a carrier sheet 20 shaped and sized to substantially match the shape and size of a user upper lip when stretched into a broad smile, the upper lip applicator 10A being impregnated with lipstick pigment material P. Also included is a lower lip applicator 10B in the form of a carrier sheet 20 shaped and sized to substantially match the shape and size of a user lower lip, once again when stretched into a broad smile, the lower lip applicator 10B being impregnated with lipstick pigment material P. See FIG. 6.

A method of using the lipstick applicator set 10 is thus provided, including the steps of smiling broadly, stretching the lips wide, slightly opening the mouth, placing the upper applicator 10A to the center of the upper lip and the lower applicator 10B to the lower lip, so that applicators 10A and 10B are aligned with the perimeter lines of the user upper and lower lips, and then starting at the center and working outwardly, using the index fingers to gently smooth the applicator against the upper and lower lips. Lipstick and lip liner pigment material P are provided together on one applicator 10A and 10B in different colors.

### Instant Lip Applicator

The present instant lip applicator 10 is designed to apply a few pigment material colors in a desired pattern to both user lips L at once. Instead of outlining the lips with the cosmetic pencil and then filling in lipstick or a lip gloss, and then using a highlighter in a middle to achieve a plumped look, the instant lip applicator 10 accomplishes all of this in one touch. It is contemplated that the applicator 10 be manufactured in a wide variety of different shapes, different pigment material P color combinations, different formulas, such as dry, hydrating, plumpers, and glossy and with exfoliators. The applicator 10 is manufactured very inexpensively for one time use, to be disposable.

### Instant Eye Concealer Applicator

The present eye concealer applicators 10 are used to press-on and thus transfer pigment material P onto user skin below user eyes to conceal dark circles under the eyes, and onto skin above the eyes. To conceal dark circles under the eye area, concealers are used in the form of a cream (cream concealers), paste, make-up foundation, and mineral loose powder matching the skin tone of a person. Often, color correcting concealers are used under them to neutralize the blue tone of a dark under eye area. For example: pink pigment is applied first, then beige pigments on top of the pink pigment. When it is applied by hand with a finger or with a brush it is very difficult to control the layer and even harder to blend products such as pigments materials P together, and hygiene is frequently a problem.

The under eye concealer applicator 10 permits application of two products (a color corrector with a concealer) in a perfectly blended pre-measured layer. To minimize puffiness, colors in the formulas can be fortified with the treatment, with vitamins, sun protection, primers and so on.

The applicator 10 preferably is for one use only, and is disposable. It could be made in different shapes, formulas and color combinations. See FIG. 7.

The eye concealer provides a guard for eyelash make-up or for loose powder eyeshadow, serving as a cover or masking sheet. It can be placed under or above the user eyelash line to protect user skin from mascara. See FIGS. 14-16. Instead of a concealer any substance can be applied, namely, eye gel, cream, glue which is non-toxic, non-irritating.

### Nail Pigment Applicator and Method of Use

A nail pigment applicator 10 is provided including a nail applicator carrier sheet 20 having substantially parallel sides and rounded ends to correspond to the general shape a finger nail N and having the approximate size of a finger nail N. A color pattern or a single color formed of transfer pigment material P is provided on the carrier sheet 20. See FIG. 8.

To use the nail applicator, the user presses the carrier sheet forward face 22 onto the bed of the nail N and tilts the sheet 20 down against the nail N, and then removes the sheet 20, leaving a transferred pigment material P color pattern. Then the user seals the pigment material P color pattern onto the nail N by applying clear nail polish.

### Instant Eye Brow Applicator

On the present market few products exist to help women to draw two identical or mirror image (left and right) eye brows: eye brow stencils (you need to place one stencil to the face in the eye brow bone area and hold it with one hand, at the same time with the other hand, holding a brush with the powder or a cosmetic pencil, and the user fills in the color inside the stencil. It is very difficult to execute with a good result. In order for powder to adhere more securely to the skin, wax is applied to the brow before the powder, which makes this prior procedure even more complicated. In addition, eyebrow groomer, whether colored paste or jell, is used to color the eyebrow hair.

The present eye brow applicator 10 permits one touch printing of perfectly shaped eyebrow images onto user eye brow hair and skin at once. The eye brow applicator 10 can be used in any color and in different shapes to color eye brows and as a guiding line to tweeze or wax extra hair around the brow. The eye brow applicator 10 can have a design or pattern with the highlighter on one pad of sheet forward face 22, as shown in FIGS. 9 and 10. A handle segment H is provided at each applicator 10 end.

Under the brow line the applicator 10 instantly adds lift, life and a playful appearance to the entire eye area. Pre-measured color delivers rich, long-lasting eyebrow color. It shapes and enhances the brow line, and is economical and safe to use.

### Instant Eye Shadow Applicator

The present applicator 10, when used to apply eye shadow, prevents delicate eye area from stretching, unlike brush and sponge applicators which pull skin.

### Instant Blush Applicator

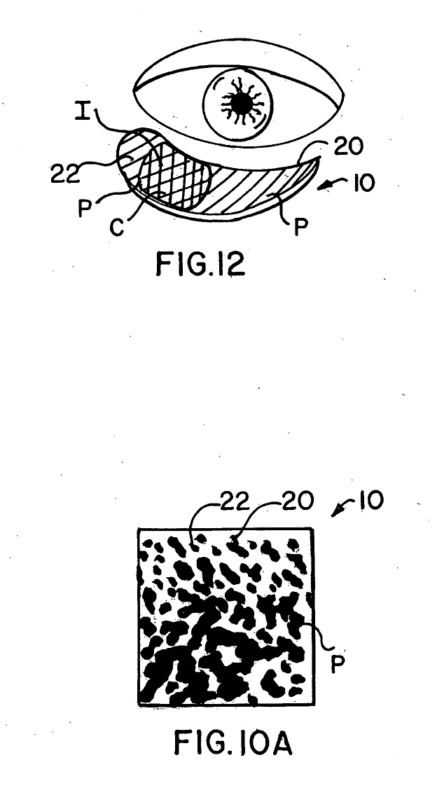

The present blush applicator combines contouring, main and highlighting colors on one pad or carrier 20. The applicator 10 is provided in various shapes to be selected according to the shape of the user face, as in FIGS. 11-14 and in different color combinations, different cosmetic material C formulas: dry powders, creams, jells, tinted primers, liquid pigments and so on, and is not limited to treatment and sun protection.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. A press-on cosmetic material applicator, comprising:
a carrier sheet having a sheet forward face hand having a sheet rearward face and retaining a pre-measured amount of pigment material configured to define an image.

2. The applicator of claim 1, wherein said cosmetic material comprises at least a single pigment configured to define an image.

3. The applicator of claim 1, wherein said cosmetic material comprises a plurality of pigments configured to define an image.

4. The applicator of claim 1, wherein said cosmetic material comprises at least one of: a vitamin, a moisturizer, an anti-microbial agent, an antibacterial agent, organic material, non-organic material, a jell, an exfoliator, a medication, a skin treatment, a deodorant and a tanning lotion.

5. The applicator of claim 2, wherein said image is a region having an image perimeter containing said pigment material and having a specific image perimeter shape and size.

6. The applicator of claim 5, wherein said image perimeter shape is the shape of one of: a human lip, a human eyebrow, and human fingernail.

7. The applicator of claim 1, wherein said forward face of said carrier sheet is substantially fully covered with said pigment material and wherein said carrier sheet has a sheet perimeter with a sheet perimeter shape of one of: a human lip, a human eyebrow, and a human fingernail.

8. The applicator of claim 1, wherein pigment material comprises one of: instant powder, lipstick, eye shadow, blush, eye concealer, mascara lip liner, eye liner and nail polish.

9. The applicator of claim 1, wherein said carrier sheet is formed of inexpensive material to be disposable.

10. The applicator of claim 1, wherein said carrier sheet is formed of sheet material comprising woven material.

11. The applicator of claim 1, wherein said carrier sheet is formed of sheet material comprising non-woven material.

12. The applicator of claim 1, wherein said sheet forward face retains said cosmetic material and a sheet rearward face comprising one of: a finger receiving pocket and a finger receiving loop for receiving at least one user finger with which the user holds and moves said carrier sheet for cosmetic material application.

13. A method of manufacturing a press-on cosmetic material applicator, comprising the steps of:
providing a carrier sheet having a sheet forward face and a sheet rearward face;
spraying the sheet forward face with cosmetic material in at least one coat.

14. The method of claim 13, wherein the cosmetic material comprises pigment materials and wherein of varying levels of darkness the step of spraying the sheet forward face with cosmetic material comprises the sub-steps of: spraying a first coat of the lightest pigment material shade; then spraying a second coat of darker pigment material onto the first coat, and then spraying a third coat of still darker pigment material onto the second coat.

15. The method of claim 13, wherein the cosmetic material is one of: sprayed, printed and pressed onto the carrier sheet forward face through a wet process, such that the cosmetic material remains on the sheet forward face until transferred directly to user skin.

16. The method of claim 13, comprising the additional step of curing the cosmetic material with ultraviolet light to sterilize the cosmetic material and to eliminate the need for preservatives.

17. (canceled)

18. (canceled)

19. A method of using an eyeliner applicator comprising a carrier sheet having a sheet forward face hand having a sheet rearward face and retaining a pre-measured amount of pigment material configured to define an image, comprising the steps of:
the user smiling;
the user stretching user lips wide and slightly opening the user mouth;
placing the carrier sheet forward face to substantially the center of the corresponding user lip such that the image is aligned with the perimeter lines of the user lip, and then starting at the center and working outwardly, using fingers to smooth the carrier sheet against the user lip.

20. The method of claim 19, wherein the carrier sheet provides a guard for one of eyelash make-up and eyeshadow, functioning as a masking sheet.
